(19) United States
(12) Patent Application Publication
(10) Pub. No.: US 2026/0184307 A1
(43) Pub. Date: Jul. 2, 2026

(54) Precise Control For An Autonomous Vehicle

(71) Applicant: Nissan North America, Inc., Franklin, TN (US)

(72) Inventors: Huiching Chen, San Jose, CA (US); Drew Steeves, San Lorenzo, CA (US); Christopher Ostafew, Mountain View, CA (US); Qizhan Tam, San Jose, CA (US)

(21) Appl. No.: 19/004,738

(22) Filed: Dec. 30, 2024

(51) Int. Cl. B60W 30/14; B60W 50/06; B60W 60/00

(52) U.S. Cl. CPC B60W 30/143; B60W 50/06; B60W 60/0015; B60W 2520/14; B60W 2520/20; B60W 2520/26; B60W 2520/28

(57) ABSTRACT

An autonomous vehicle uses precise control that is particularly useful with difficult scenes such as ultra narrow scenes. A plan including a planned path and a speed plan for the autonomous vehicle to traverse through a portion of a vehicle transportation network is received from a trajectory planner. An optimization operation is performed to revise the plan, where the optimization operation minimizes a lateral and heading error as compared to the planned path while applying each of a lateral offset constraint and a heading angle constraint as soft constraints. The soft constraints are represented by respective slack variables, and a penalty is applied to at least one of the slack variables that is greater than a penalty applied to the lateral and heading error to prioritize collision avoidance over maintaining the planned path. At least one control system of the autonomous vehicle is operated according to the plan as revised.

### TECHNICAL FIELD

This disclosure relates generally to precise vehicle control, particularly precise control for autonomous or semi-autonomous vehicles navigating complicated scenes.

### BACKGROUND

A vehicle may traverse a portion of a vehicle transportation network (e.g., a road). Traversing the portion of the vehicle transportation network may include generating or capturing, such as by a sensor of the vehicle, data, such as data representing an operational environment, or a portion thereof, of the vehicle. Traversing the portion of the vehicle transportation network may include controlling an action of an autonomous vehicle in response to the captured data. Scenes represented by the captured data over time may be complicated and require precise control.

### SUMMARY

Disclosed herein are aspects, features, elements, implementations, and embodiments for precise control of an autonomous vehicle.

An aspect of the disclosed embodiments is an apparatus for controlling an autonomous vehicle. The apparatus includes a processor configured to receive, from a trajectory planner, a plan comprising a planned path and a speed plan for the autonomous vehicle to traverse through a portion of a vehicle transportation network, perform an optimization operation to revise the plan, wherein the optimization operation jointly minimizes a lateral and heading error as compared to the planned path while applying each of a lateral offset constraint and a heading angle constraint as soft constraints, wherein the soft constraints are represented by respective slack variables, and a penalty is applied to at least one of the slack variables that is greater than a penalty applied to the lateral and heading error to prioritize collision avoidance over maintaining the planned path, and operate at least one control system of the autonomous vehicle according to the plan as revised.

In some implementations, the processor is configured to determine the lateral and heading error using state variables generated using a dynamic bicycle predictive model.

The state variables can include a side slip angle, a yaw rate, a heading error, and a lateral error where the yaw rate is an estimated yaw rate that varies according to a longitudinal slip ratio. In a variation of these implementations, the processor is configured to determine the side slip angle using the yaw rate as input to a sliding mode observer and a linear adaptive tire force model.

The state variables can include a side slip angle, a filtered yaw rate, a heading error, and a lateral error, where the processor is configured to determine the filtered yaw rate by estimating a yaw rate that considers a longitudinal slip ratio using wheel speed and acceleration of the autonomous vehicle as input, and filtering sensor noise from the yaw rate as estimated. In a variation of these implementations, the processor is configured to filter sensor noise by determining a weighted average of an estimation of the yaw rate assuming a nonzero tire slip and an estimation of the yaw rate assuming a zero tire slip when the autonomous vehicle decelerates, wherein a weight of the estimation of the yaw rate assuming the nonzero tire slip increases as deceleration increases.

In some implementations, the slack variables vary based on a distance of the autonomous vehicle to at least one of a boundary or an obstacle.

In some implementations, the optimization operation jointly minimizes the lateral and heading error as compared to the planned path and steering oscillations.

In some implementations, the processor is configured to, once the lateral and heading error between a current state of the autonomous vehicle and a desired state of the autonomous vehicle is above a threshold, implement error state saturation logic to restrict a maximum rate of change of a steering angle to limit overcorrection at a future point in a prediction horizon. In a variation, the error state saturation logic is enabled or disabled depending on at least one of a condition of the autonomous vehicle or a condition of the portion of the vehicle transportation network. In an example, the error state saturation logic is enabled when at least one of a curvature of a lane in the portion of the vehicle transportation network is less than a minimum threshold and a speed of the autonomous vehicle is greater than a maximum threshold.

In some implementations, the processor is configured to determine a state prediction for the autonomous vehicle for use in the optimization operation, and determine, using the state prediction, a speed reduction for the optimization operation based on a lookahead curvature of the planned path and steering slew rate limitations of the autonomous vehicle. In a variation, the processor is configured to access speed-based and curvature-based tuning parameters from a lookup table to determine a speed reduction for multiple time points.

In some implementations, the processor is configured to perform the optimization process using the lateral offset constraint applied pointwise to avoid any collision with respect to a front bumper of the autonomous vehicle and using the heading angle constraint to avoid any collision with respect to a rear bumper of the autonomous vehicle. The lateral offset constraint is based on at least one of a boundary or an obstacle, and the heading angle constraint is calculated from a rear axle of the autonomous vehicle considering a width of the autonomous vehicle.

An aspect of the disclosed embodiments is an autonomous vehicle that includes any apparatus for controlling the autonomous vehicle described above.

An aspect of the disclosed embodiments is a method for controlling an autonomous vehicle. The method includes receiving, from a trajectory planner, a plan comprising a planned path and a speed plan for the autonomous vehicle to traverse through a portion of a vehicle transportation network, performing an optimization operation to revise the plan, wherein the optimization operation jointly minimizes a lateral and heading error as compared to the planned path while applying each of a lateral offset constraint and a heading angle constraint as soft constraints, wherein the soft constraints are represented by respective slack variables, and a penalty is applied to at least one of the slack variables that is greater than a penalty applied to the lateral and heading error to prioritize collision avoidance over maintaining the planned path, and operating at least one control system of the autonomous vehicle according to the plan as revised.

In some implementations, the method includes determining the lateral and heading error using state variables including a side slip angle, a yaw rate, a heading error, and a lateral error generated using a dynamic bicycle predictive model for the autonomous vehicle.

In some implementations, the slack variables vary based on a distance of the autonomous vehicle to at least one of a boundary or an obstacle.

In some implementations, the optimization operation jointly minimizes the lateral and heading error as compared to the planned path and steering oscillations.

In some implementations, the method includes determining a speed reduction for the optimization operation based on a lookahead curvature of the planned path and steering slew rate limitations of the autonomous vehicle, and providing the speed reduction as input to the optimization operation.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of an example of an autonomous vehicle operational management system in accordance with embodiments of this disclosure.

FIG. 4 is a diagram of a data pipeline of a vehicle decision-making system.

FIG. 5 is a diagram of a vehicle control system incorporating the vehicle decision-making system of FIG. 4.

FIG. 6 is a diagram of an observer used for yaw rate estimation.

FIG. 7 is a graph of deceleration as compared to a first weight for a slip angle w₁ and a second weight for a slip angle w₂.

FIG. 8 is a diagram of an observer used for slip angle estimation.

FIG. 9 is a diagram used to describe the parameters for the estimation by the observer of FIG. 8.

FIGS. 10A and 10B are graphs used to explain speed compensation for steering actuator limitations.

FIG. 11 is a flow chart of a method for precise control of an autonomous vehicle.

### DETAILED DESCRIPTION

A vehicle, such as an autonomous vehicle (AV), or a semi-autonomous vehicle, may traverse a portion of a vehicle transportation network. The vehicle may include one or more sensors and traversing the vehicle transportation network may include the sensors generating or capturing sensor data, such as sensor data corresponding to an operational environment of the vehicle, or a portion thereof. For example, the sensor data may include information corresponding to one or more external objects, such as pedestrians, remote vehicles, other objects within the vehicle operational environment, vehicle transportation network geometry, or a combination thereof. As used herein, an AV encompasses a semi-autonomous vehicle. A semi-autonomous vehicle may be, for example, any vehicle including one or more advanced-driver assistance systems (ADAS).

During autonomous driving, and at different time steps (e.g., at every time step), some component (e.g., a decision-making component, module, or model such as a reasoning module, an inference module, or the like) of the AV may determine a respective action for controlling the AV in response to sensor information. Thus, at a high level, the component of the AV uses inputs (e.g., sensor data) and produces an output (e.g., the action to control the AV) where the output can be an action for controlling the AV.

The component can be a single component (e.g., module, model, circuitry, etc.), multiple cooperating components, or a command arbitration module (e.g., an executor or an autonomous vehicle operational management controller) that receives inputs (e.g., candidate actions) from multiple components and selects one of the candidate actions as the selected action for controlling the AV.

Certain of the components may be referred to as decision or decision-making components herein. Each decision component recommends an action based on a belief state of the operational environment of the vehicle (e.g., a state based on the locations of objects and the AV, headings, speed, etc.). The recommendation of an action that is a correct action (e.g., one that is appropriate for the vehicle based on the operational environment of the vehicle) depends upon accurate information about that operational environment. A trajectory planner uses these actions along time points to plan a reference path.

Precise control is desirable to command the vehicle along the desired reference path accurately while managing road-user and pedestrian intrusions, vehicle, and comfort constraints. This can be difficult in complicated driving situations, such as in ultra-narrow scenes and other potentially dynamic scenes. To address challenges involved with such situations, this disclosure integrates novel technologies linked through a Model Predictive Control (MPC) optimization framework based on a high-fidelity dynamic vehicle model to generate control commands that allow vehicle to drive through complicated scenes while generating a collision-free path.

The precise control according to the teachings herein is discussed in more detail below after an initial description of a vehicle with which the invention may be used.

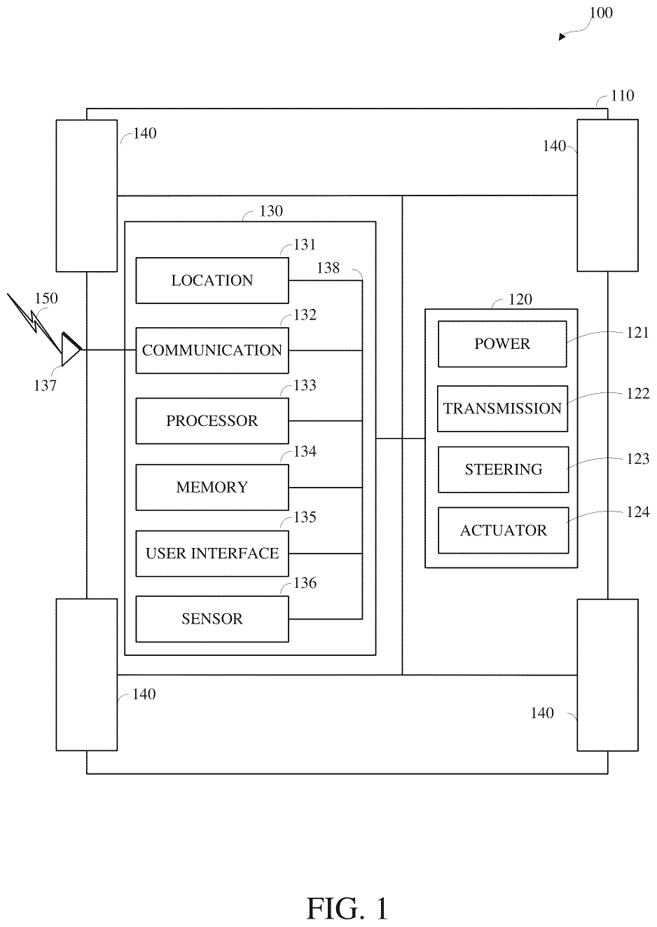

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. Although FIG. 1 shows a single communication interface 137, a vehicle may include any number of communication interfaces.

The communication unit 132 may be configured to transmit or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single communication unit 132 and a single communication interface 137, any number of communication units and any number of communication interfaces may be used. In some embodiments, the communication unit 132 may include a dedicated short-range communications (DSRC) unit, an on-board unit (OBU), or a combination thereof.

The location unit 131 may determine geolocation information, such as longitude, latitude, elevation, direction of travel, or speed, of the vehicle 100. For example, the location unit may include a GPS unit, such as a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an autonomous vehicle controlled autonomously, without direct human intervention, to traverse a portion of a vehicle transportation network. Although not shown separately in FIG. 1, an autonomous vehicle may include an autonomous vehicle control unit, which may perform autonomous vehicle routing, navigation, and control. The autonomous vehicle control unit may be integrated with another unit of the vehicle. For example, the controller 130 may include the autonomous vehicle control unit. The teachings herein are equally applicable to a semi-autonomous vehicle.

The autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network data representing the vehicle transportation network, or a combination thereof, and may control or operate the vehicle 100 to traverse the vehicle transportation network in accordance with the route. For example, the autonomous vehicle control unit may output the route of travel to the trajectory controller, and the trajectory controller may operate the vehicle 100 to travel from the origin to the destination using the generated route.

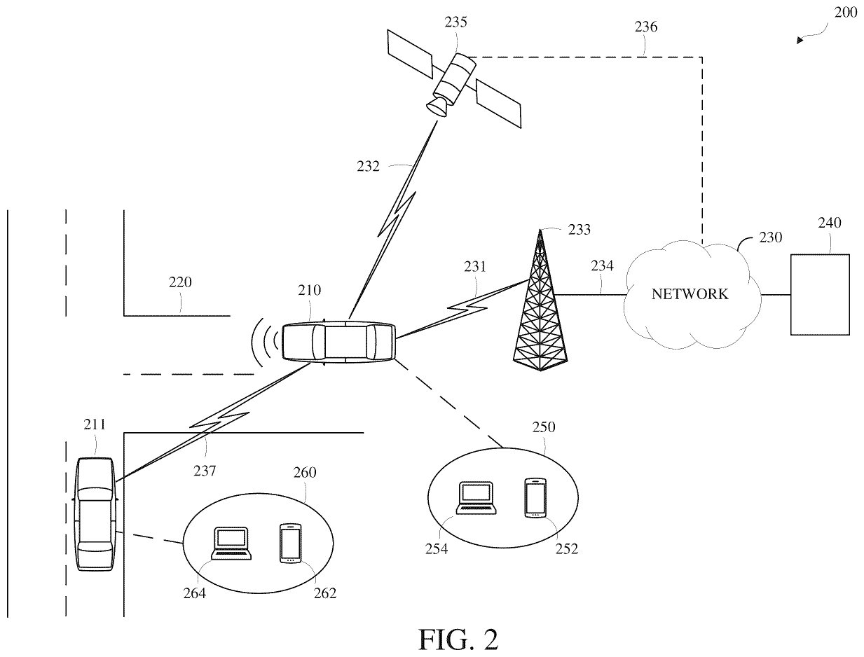

FIG. 2 is a diagram of an example of a portion of a vehicle transportation and communication system in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and the vehicle may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the network 230.

In some embodiments, a vehicle 210/211 may communicate via a wired communication link (not shown), a wireless communication link 231/232/237, or a combination of any number of wired or wireless communication links. For example, as shown, a vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, or any link capable of providing for electronic communication.

A vehicle 210/211 may communicate with another vehicle 210/2110. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit in FIG. 2, an access point may include any number of interconnected elements.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide for voice, data, or any other type of electronic communication. For example, the electronic communication network 230 may include a local area network (LAN), a wide area network (WAN), a virtual private network (VPN), a mobile or cellular telephone network, the Internet, or any other electronic communication system. The electronic communication network 230 may use a communication protocol, such as the transmission control protocol (TCP), the user datagram protocol (UDP), the internet protocol (IP), the real-time transport protocol (RTP), the HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, and one communication device 240, any number of vehicles, networks, or computing devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210/211 may be associated with an entity 250/260, such as a driver, operator, or owner of the vehicle. In some embodiments, an entity 250/260 associated with a vehicle 210/211 may be associated with one or more personal electronic devices 252/254/262/264, such as a smartphone 252/262 or a computer 254/264. In some embodiments, a personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

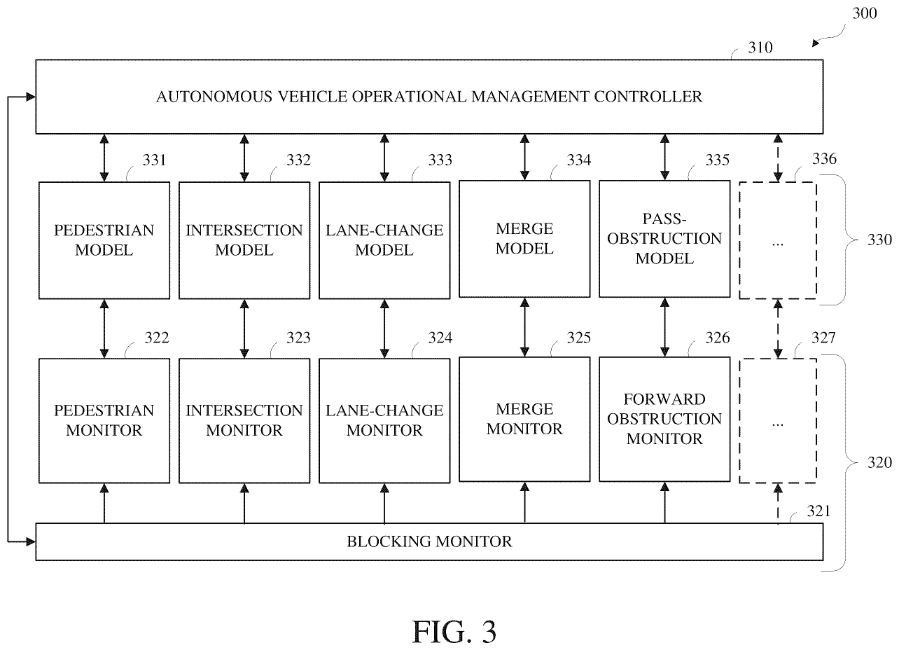

FIG. 3 is a diagram of an example of an autonomous vehicle operational management system 300 in accordance with embodiments of this disclosure. The autonomous vehicle operational management system 300 may be implemented in an autonomous vehicle, such as the vehicle 100 shown in FIG. 1, one of the vehicles 210/211 shown in FIG. 2, a semi-autonomous vehicle, or any other vehicle implementing autonomous decision-making, at least in part.

The autonomous vehicle may traverse a vehicle transportation network, or a portion thereof, which may include traversing distinct vehicle operation scenarios. A distinct vehicle operation scenario may include any distinctly identifiable set of operative conditions that may affect the operation of the autonomous vehicle within a defined spatiotemporal area, or operational environment, of the autonomous vehicle. For example, a distinct vehicle operation scenario may be based on a number or cardinality of roads, road segments, or lanes that the autonomous vehicle may traverse within a defined spatiotemporal distance. In another example, a distinct vehicle operation scenario may be based on one or more traffic control devices that may affect the operation of the autonomous vehicle within a defined spatiotemporal area, or operational environment, of the autonomous vehicle. In another example, a distinct vehicle operation scenario may be based on one or more identifiable rules, regulations, or laws that may affect the operation of the autonomous vehicle within a defined spatiotemporal area, or operational environment, of the autonomous vehicle. In another example, a distinct vehicle operation scenario may be based on one or more identifiable external objects that may affect the operation of the autonomous vehicle within a defined spatiotemporal area, or operational environment, of the autonomous vehicle.

As shown in FIG. 3, the autonomous vehicle operational management system 300 includes an autonomous vehicle operational management controller (AVOMC) 310, operational environment monitors 320, and operation control evaluation modules (also referred to as models) 330.

The AVOMC 310 may control the vehicle to traverse the vehicle transportation network, or a portion thereof. Controlling the vehicle to traverse the vehicle transportation network may include, in some implementations, monitoring the operational environment of the vehicle, identifying or detecting distinct vehicle operation scenarios, identifying candidate vehicle control actions based on the distinct vehicle operation scenarios, and controlling the vehicle to traverse a portion of the vehicle transportation network in accordance with one or more of the candidate vehicle control actions.

The AVOMC 310 may receive, identify, or otherwise access, operational environment data representing an operational environment for the autonomous vehicle, such as a current operational environment or an expected operational environment, or one or more aspects thereof. The operational environment of the autonomous vehicle may include a distinctly identifiable set of operative conditions that may affect the operation of the autonomous vehicle within a defined spatiotemporal area of the autonomous vehicle, within a defined spatiotemporal area of an identified route for the autonomous vehicle, or a combination thereof. For example, operative conditions that may affect the operation of the autonomous vehicle may be identified based on sensor data, vehicle transportation network data, route data, or any other data or combination of data representing a defined or determined operational environment for the vehicle.

The operational environment data may include vehicle information for the autonomous vehicle, such as information indicating a geospatial location of the autonomous vehicle, information correlating the geospatial location of the autonomous vehicle to information representing the vehicle transportation network, a route of the autonomous vehicle, a speed of the autonomous vehicle, an acceleration state of the autonomous vehicle, passenger information of the autonomous vehicle, or any other information about the autonomous vehicle or the operation of the autonomous vehicle. The operational environment data may include information representing the vehicle transportation network proximate to the autonomous vehicle, an identified route for the autonomous vehicle, or both. For example, this may include information within a defined spatial distance, such as 300 meters, of portions of the vehicle transportation network along the identified route, information indicating the geometry of one or more aspects of the vehicle transportation network, information indicating a condition, such as a surface condition, of the vehicle transportation network, or any combination thereof.

The operational environment data may include information representing external objects within the operational environment of the autonomous vehicle, such as information representing pedestrians, non-human animals, non-motorized transportation devices, such as bicycles or skateboards, motorized transportation devices, such as remote vehicles, or any other external object or entity that may affect the operation of the autonomous vehicle.

Aspects of the operational environment of the autonomous vehicle may be represented within respective distinct vehicle operation scenarios. For example, the relative orientation, trajectory, expected path, of external objects may be represented within respective distinct vehicle operation scenarios. In another example, the relative geometry of the vehicle transportation network may be represented within respective distinct vehicle operation scenarios.

The autonomous vehicle may traverse multiple distinct vehicle operation scenarios within an operational environment, which may be aspects of a compound vehicle operational scenario. For example, a pedestrian may approach the expected path for the autonomous vehicle traversing an intersection.

The autonomous vehicle operational management system 300 may operate or control the autonomous vehicle to traverse the distinct vehicle operation scenarios subject to defined constraints, such as safety constraints, legal constraints, physical constraints, user acceptability constraints, or any other constraint or combination of constraints that may be defined or derived for the operation of the autonomous vehicle.

The AVOMC 310 may monitor the operational environment of the autonomous vehicle, or defined aspects thereof. Monitoring the operational environment of the autonomous vehicle may include identifying and tracking external objects, identifying distinct vehicle operation scenarios, or a combination thereof. For example, the AVOMC 310 may identify and track external objects within the operational environment of the autonomous vehicle. Identifying and tracking the external objects may include identifying spatiotemporal locations of respective external objects, which may be relative to the autonomous vehicle, identifying one or more expected paths for respective external objects, which may include identifying a speed, a trajectory, or both, for an external object. For simplicity and clarity, descriptions of locations, expected locations, paths, expected paths, and the like herein may omit express indications that the corresponding locations and paths refer to geospatial and temporal components; however, unless expressly indicated herein, or otherwise unambiguously clear from context, the locations, expected locations, paths, expected paths, and the like described herein may include geospatial components, temporal components, or both. Monitoring the operational environment of the autonomous vehicle may include using operational environment data received by the operational environment monitors 320.

The operational environment monitors 320 may include scenario-agnostic monitors, scenario-specific monitors, or a combination thereof. A scenario-agnostic monitor, such as a blocking monitor 321, may monitor the operational environment of the autonomous vehicle, generate operational environment information representing aspects of the operational environment of the autonomous vehicle, and output the operational environment information to one or more scenario-specific monitors, the AVOMC 310, or a combination thereof, as discussed in further detail below. A scenario-specific monitor, such as a pedestrian monitor 322, an intersection monitor 323, a lane-change monitor 324, a merge monitor 325, or a forward obstruction monitor 326, may monitor the operational environment of the autonomous vehicle, generate operational environment information representing scenario-specific aspects of the operational environment of the autonomous vehicle, and output the operational environment information to one or more operation control evaluation models 330, the AVOMC 310, or a combination thereof.

For example, the pedestrian monitor 322 may be an operational environment monitor for monitoring pedestrians, the intersection monitor 323 may be an operational environment monitor for monitoring intersections, the lane-change monitor 324 may be an operational environment monitor for monitoring lane-changes, the merge monitor 325 may be an operational environment monitor for merges, and the forward obstruction monitor 326 may be an operational environment monitor for monitoring forward obstructions. An operational environment monitor 327 is shown using broken lines to indicate that the autonomous vehicle operational management system 300 may include any number of operational environment monitors 320.

An operational environment monitor 320 may receive, or otherwise access, operational environment data, such as operational environment data generated or captured by one or more sensors of the autonomous vehicle, vehicle transportation network data, vehicle transportation network geometry data, route data, or a combination thereof. For example, the pedestrian monitor 322 may receive, or otherwise access, information, such as sensor data, which may indicate, correspond to, or may otherwise be associated with, one or more pedestrians in the operational environment of the autonomous vehicle. An operational environment monitor 320 may associate the operational environment data, or a portion thereof, with the operational environment, or an aspect thereof, such as with an external object, such as a pedestrian, a remote vehicle, or an aspect of the vehicle transportation network geometry.

An operational environment monitor 320 may generate, or otherwise identify, information representing one or more aspects of the operational environment, such as with an external object, such as a pedestrian, a remote vehicle, or an aspect of the vehicle transportation network geometry, which may include filtering, abstracting, or otherwise processing the operational environment data. An operational environment monitor 320 may output the information representing the one or more aspects of the operational environment to, or for access by, the AVOMC 310, such by storing the information representing the one or more aspects of the operational environment in a memory, such as the memory 134 shown in FIG. 1, of the autonomous vehicle accessible by the AVOMC 310, sending the information representing the one or more aspects of the operational environment to the AVOMC 310, or a combination thereof. An operational environment monitor 320 may output the operational environment information to one or more elements of the autonomous vehicle operational management system 300, such as the AVOMC 310. Although not shown in FIG. 3, a scenario-specific operational environment monitor 322, 323, 324, 325, 326 may output operational environment data or the derived operational environment information to a scenario-agnostic operational environment monitor, such as the blocking monitor 321.

The pedestrian monitor 322 may correlate, associate, or otherwise process the operational environment data to identify, track, or predict actions of one or more pedestrians. For example, the pedestrian monitor 322 may receive information, such as sensor data, from one or more sensors, which may correspond to one or more pedestrians, the pedestrian monitor 322 may associate the sensor data with one or more identified pedestrians, which may include may identifying a direction of travel, a path, such as an expected path, a current or expected velocity, a current or expected acceleration rate, or a combination thereof for one or more of the respective identified pedestrians, and the pedestrian monitor 322 may output the identified, associated, or generated pedestrian information to, or for access by, the AVOMC 310.

The intersection monitor 323 may correlate, associate, or otherwise process the operational environment data to identify, track, or predict actions of one or more remote vehicles in the operational environment of the autonomous vehicle, to identify an intersection, or an aspect thereof, in the operational environment of the autonomous vehicle, to identify vehicle transportation network geometry, or a combination thereof. For example, the intersection monitor 323 may receive information, such as sensor data, from one or more sensors, which may correspond to one or more remote vehicles in the operational environment of the autonomous vehicle, the intersection, or one or more aspects thereof, in the operational environment of the autonomous vehicle, the vehicle transportation network geometry, or a combination thereof, the intersection monitor 323 may associate the sensor data with one or more identified remote vehicles in the operational environment of the autonomous vehicle, the intersection, or one or more aspects thereof, in the operational environment of the autonomous vehicle, the vehicle transportation network geometry, or a combination thereof, which may include may identifying a current or expected direction of travel, a path, such as an expected path, a current or expected velocity, a current or expected acceleration rate, or a combination thereof for one or more of the respective identified remote vehicles. The intersection monitor 323 may output the identified, associated, or generated intersection information to, or for access by, the AVOMC 310.

The lane-change monitor 324 may correlate, associate, or otherwise process the operational environment data to identify, track, or predict actions of one or more remote vehicles in the operational environment of the autonomous vehicle, such as information indicating a slow or stationary remote vehicle along the expected path of the autonomous vehicle, to identify one or more aspects of the operational environment of the autonomous vehicle, such as vehicle transportation network geometry in the operational environment of the autonomous vehicle, or a combination thereof geospatially corresponding to a lane-change operation. For example, the lane-change monitor 324 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a lane-change operation, the lane-change monitor 324 may associate the sensor data with one or more identified remote vehicles in the operational environment of the autonomous vehicle, one or more aspects of the operational environment of the autonomous vehicle or a combination thereof geospatially corresponding to a lane-change operation, which may include may identifying a current or expected direction of travel, a path, such as an expected path, a current or expected velocity, a current or expected acceleration rate, or a combination thereof for one or more of the respective identified remote vehicles. The lane-change monitor 324 may output the identified, associated, or generated lane-change information to, or for access by, the AVOMC 310

The merge monitor 325 may correlate, associate, or otherwise process the operational environment information to identify, track, or predict actions of one or more remote vehicles in the operational environment of the autonomous vehicle, to identify one or more aspects of the operational environment of the autonomous vehicle, such as vehicle transportation network geometry in the operational environment of the autonomous vehicle, or a combination thereof geospatially corresponding to a merge operation. For example, the merge monitor 325 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a merge operation, the merge monitor 325 may associate the sensor data with one or more identified remote vehicles in the operational environment of the autonomous vehicle, one or more aspects of the operational environment of the autonomous vehicle or a combination thereof geospatially corresponding to a merge operation, which may include identifying a current or expected direction of travel, a path, such as an expected path, a current or expected velocity, a current or expected acceleration rate, or a combination thereof for one or more of the respective identified remote vehicles. The merge monitor 325 may output the identified, associated, or generated merge information to, or for access by, the AVOMC 310.

The forward obstruction monitor 326 may correlate, associate, or otherwise process the operational environment information to identify one or more aspects of the operational environment of the autonomous vehicle geospatially corresponding to a forward pass-obstruction operation. For example, the forward obstruction monitor 326 may identify vehicle transportation network geometry in the operational environment of the autonomous vehicle. The forward obstruction monitor 326 may identify one or more obstructions or obstacles in the operational environment of the autonomous vehicle, such as a slow or stationary remote vehicle along the expected path of the autonomous vehicle or along an identified route for the autonomous vehicle; and the forward obstruction monitor 326 may identify, track, or predict actions of one or more remote vehicles in the operational environment of the autonomous vehicle. The forward obstruction monitor 326 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a forward pass-obstruction operation. The forward obstruction monitor 326 may associate the sensor data with one or more identified remote vehicles in the operational environment of the autonomous vehicle, one or more aspects of the operational environment of the autonomous vehicle or a combination thereof geospatially corresponding to the forward pass-obstruction operation, which may include may identifying a current or expected direction of travel, a path, such as an expected path, a current or expected velocity, a current or expected acceleration rate, or a combination thereof for one or more of the respective identified remote vehicles. The forward obstruction monitor 326 may output the identified, associated, or generated forward obstruction information to, or for access by, the AVOMC 310.

While shown as an operation environment monitor 320, the blocking monitor 321 may be a separate monitoring device. The blocking monitor 321 may receive operational environment data representing an operational environment, or an aspect thereof, for the vehicle. For example, the blocking monitor 321 may receive the operational environment data from the AVOMC 310, from a sensor of the vehicle, from an external device, such as a remote vehicle or an infrastructure device, or a combination thereof. The blocking monitor 321 may read the operational environment data, or a portion thereof, from a memory, such as a memory of the autonomous vehicle, such as the memory 134 shown in FIG. 1.

The blocking monitor 321, using this input, may determine a respective probability of availability (POA), or corresponding blocking probability, for one or more portions of the vehicle transportation network, such as portions of the vehicle transportation network proximal to the autonomous vehicle, which may include portions of the vehicle transportation network corresponding to an expected path of the autonomous vehicle, such as an expected path identified based on a current route of the autonomous vehicle. A probability of availability, or corresponding blocking probability, may indicate a probability or likelihood that the autonomous vehicle may traverse a portion of, or spatial location within, the vehicle transportation network safely, such as unimpeded by an external object, such as a remote vehicle or a pedestrian. For example, a portion of the vehicle transportation network may include an obstruction, such as a stationary object, and a probability of availability for the portion of the vehicle transportation network may be low, such as 0%, which may be expressed as a high blocking probability, such as 100%, for the portion of the vehicle transportation network. The blocking monitor 321 may identify a respective probability of availability for each of multiple portions of the vehicle transportation network within an operational environment, such as within 300 meters, of the autonomous vehicle. The blocking monitor 321 may determine, or update, probabilities of availability continually or periodically. The blocking monitor 321 may communicate probabilities of availability, or corresponding blocking probabilities, to the AVOMC 310.

A probability of availability may be indicated by the blocking monitor 321 corresponding to each external object in the operational environment of the autonomous vehicle and a geospatial area may be associated with multiple probabilities of availability corresponding to multiple external objects. An aggregate probability of availability may be indicated by the blocking monitor 321 corresponding to each type of external object in the operational environment of the autonomous vehicle, such as a probability of availability for pedestrians and a probability of availability for remote vehicles, and a geospatial area may be associated with multiple probabilities of availability corresponding to multiple external object types.

The blocking monitor 321 may identify external objects, track external objects, project location information, path information, or both for external objects, or a combination thereof. For example, the blocking monitor 321 may identify an external object and identify an expected path for the external object based on operational environment information (e.g., a current location of the external object), information indicating a current trajectory and/or speed for the external object, information indicating a type of classification of the external object (e.g., a pedestrian or a remote vehicle), vehicle transportation network information (e.g., a crosswalk proximate to the external object), previously identified or tracked information associated with the external object, or any combination thereof. The expected path may indicate a sequence of expected spatial locations, expected temporal locations, and corresponding probabilities.

The blocking monitor 321 may communicate probabilities of availability, or corresponding blocking probabilities, to the AVOMC 310. The AVOMC 310 may communicate the probabilities of availability, or corresponding blocking probabilities, to respective instantiated instances of the operational control evaluation models 330.

The AVOMC 310 may identify one or more distinct vehicle operation scenarios based on one or more aspects of the operational environment represented by the operational environment information. For example, the AVOMC 310 may identify a distinct vehicle operation scenario in response to identifying, or based on, the operational environment information indicated by one or more of the operational environment monitors 320. The distinct vehicle operation scenario may be identified based on route data, sensor data, or a combination thereof. For example, the AVOMC 310 may identify one or multiple distinct vehicle operation scenarios corresponding to an identified route for the vehicle, such as based on map data corresponding to the identified route, in response to identifying the route. Multiple distinct vehicle operation scenarios may be identified based on one or more aspects of the operational environment represented by the operational environment information. For example, the operational environment information may include information representing a pedestrian approaching an intersection along an expected path for the autonomous vehicle, and the AVOMC 310 may identify a pedestrian vehicle operational scenario, an intersection vehicle operational scenario, or both.

The AVOMC 310 may instantiate respective instances of one or more of the operation control evaluation models 330 based on one or more aspects of the operational environment represented by the operational environment information, such as the identification of an upcoming scenario. An upcoming scenario may be a distinct vehicle operation scenario that the AVOMC 310 determines that the autonomous vehicle is likely to encounter if it continues in its path. Upcoming scenarios may be expected (e.g., can be determined from the route of the autonomous vehicle) or unexpected. An unexpected upcoming scenario may be a scenario that can be detected by the sensors of the vehicle and cannot be determined without sensor data.

The operation control evaluation models 330 may include scenario-specific operation control evaluation model (SSOCEMs), such as a pedestrian-SSOCEM 331, an intersection-SSOCEM 332, a lane-change-SSOCEM 333, a merge-SSOCEM 334, a pass-obstruction-SSOCEM 335, or a combination thereof. A SSOCEM 336 is shown using broken lines to indicate that the autonomous vehicle operational management system 300 may include any number of SSOCEMs 330. For example, the AVOMC 310 may instantiate an instance of a SSOCEM 330 in response to identifying a distinct vehicle operation scenario. The AVOMC 310 may instantiate multiple instances of one or more SSOCEMs 330 based on one or more aspects of the operational environment represented by the operational environment data. For example, the operational environment data may indicate two pedestrians in the operational environment of the autonomous vehicle and the AVOMC 310 may instantiate a respective instance of the pedestrian-SSOCEM 331 for each pedestrian.

The AVOMC 310 may send the operational environment information, or one or more aspects thereof, to another unit of the autonomous vehicle, such as the blocking monitor 321 or one or more instances of the SSOCEMs 330. For example, the AVOMC 310 may communicate the probabilities of availability, or corresponding blocking probabilities, received from the blocking monitor 321 to respective instantiated instances of the SSOCEMs 330. The AVOMC 310 may store the operational environment information, or one or more aspects thereof, such as in a memory, such as the memory 134 shown in FIG. 1, of the autonomous vehicle.

Although not expressly shown in FIG. 3, the autonomous vehicle operational management system 300 may include a predictor module that may generate and send prediction information to the blocking monitor 321, and the blocking monitor 321 may output probability of availability information to one or more of the other operational environment monitors 320.

A SSOCEM 330, once instantiated, can receive the operational environment information, which may include sensor data, to determine and output a candidate vehicle control action, also called a candidate action herein. A candidate action is a vehicle control action that is identified by the particular SSOCEM 330 as the likely optimal action for the vehicle to perform that will handle a particular scenario. For instance, a SSOCEM 330 configured to handle intersections (e.g., an intersection SSOCEM-332) may output a “proceed”, a candidate action that suggests proceeding through an intersection. At the same time, a SSOCEM 330 for handling lane changes (e.g., the lane change SSOCEM 333) may output a “turn left” candidate action indicating that the vehicle should merge left by two degrees. In some implementations, each SSOCEM 330 outputs a confidence score indicating a degree of confidence in the candidate action determined by the SSOCEM 330. For instance, a confidence score greater than 0.95 may indicate a very high confidence in the candidate action, while a confidence score less than 0.5 may indicate a relatively low degree of confidence in the candidate action. Further details of a SSOCEM 330 are described below.

The AVOMC 310 may receive one or more candidate actions from respective instances of the SSOCEMs 330. The AVOMC 310 may identify a vehicle control action from the candidate vehicle control actions, and may control the vehicle, or may provide the identified vehicle control action to another vehicle control unit, to traverse the vehicle transportation network in accordance with the vehicle control action.

A vehicle control action may indicate a vehicle control operation or maneuver, such as accelerating, decelerating, turning, stopping, or any other vehicle operation or combination of vehicle operations that may be performed by the autonomous vehicle in conjunction with traversing a portion of the vehicle transportation network. For example, an ‘advance’ vehicle control action may include slowly inching forward a short distance, such as a few inches or a foot; an ‘accelerate’ vehicle control action may include accelerating a defined acceleration rate, or at an acceleration rate within a defined range; a ‘decelerate’ vehicle control action may include decelerating a defined deceleration rate, or at a deceleration rate within a defined range; a ‘maintain’ vehicle control action may include maintaining current operational parameters, such as by maintaining a current velocity, a current path or route, or a current lane orientation; and a ‘proceed’ vehicle control action may include beginning or resuming a previously identified set of operational parameters. Although some vehicle control actions are described herein, other vehicle control actions may be used.

A vehicle control action may include one or more performance metrics. For example, a ‘stop’ vehicle control action may include a deceleration rate as a performance metric. In another example, a ‘proceed’ vehicle control action may expressly indicate route or path information, speed information, an acceleration rate, or a combination thereof as performance metrics, or may expressly or implicitly indicate that a current or previously identified path, speed, acceleration rate, or a combination thereof may be maintained.

A vehicle control action may be a compound vehicle control action, which may include a sequence, combination, or both of vehicle control actions. For example, an ‘advance’ vehicle control action may indicate a ‘stop’ vehicle control action, a subsequent ‘accelerate’ vehicle control action associated with a defined acceleration rate, and a subsequent ‘stop’ vehicle control action associated with a defined deceleration rate, such that controlling the autonomous vehicle in accordance with the ‘advance’ vehicle control action includes controlling the autonomous vehicle to slowly inch forward a short distance, such as a few inches or a foot.

In some implementations, the AVOMC 310 utilizes hardcoded logic to determine the vehicle control action from the candidate actions. For example, the AVOMC 310 may select the candidate action having the highest confidence score. In other implementations, the AVOMC 310 may select the candidate action that is the least likely to result in a collision. In other implementations, the AVOMC 310 may generate a compound action based on two or more non-conflicting candidate actions (e.g., compounding ‘proceed’ and ‘turn left by two degrees’ to result in a vehicle control action that causes the vehicle to veer left and proceed through an intersection). In some implementations, the AVOMC 310 may utilize a machine learning algorithm to determine a vehicle control action based on two or more differing candidate actions.

For example, identifying the vehicle control action from the candidate actions may include implementing a machine learning component, such as supervised learning of a classification problem, and training the machine learning component using examples, such as 1000 examples, of the corresponding vehicle operational scenario. In another example, identifying the vehicle control action from the candidate actions may include implementing a Markov Decision Process (MDP), or a Partially Observable Markov Decision Process (POMDP), which may describe how respective candidate actions affect subsequent candidate actions, and may include a reward function that outputs a positive or negative reward for respective vehicle control actions.

The AVOMC 310 may uninstantiate an instance of a SSOCEM 330. For example, the AVOMC 310 may identify a distinct set of operative conditions as indicating a distinct vehicle operation scenario for the autonomous vehicle, instantiate an instance of a SSOCEM 330 for the distinct vehicle operation scenario, monitor the operative conditions, subsequently determine that one or more of the operative conditions has expired, or has a probability of affecting the operation of the autonomous vehicle below a defined threshold, and the AVOMC 310 may uninstantiate the instance of the SSOCEM 330.

As referred to briefly above, a SSOCEM 330 may model a respective distinct vehicle operation scenario. The autonomous vehicle operational management system 300 includes any number of SSOCEMs 330, each modeling a respective distinct vehicle operation scenario. Modeling a distinct vehicle operation scenario may include generating and/or maintaining state information representing aspects of an operational environment of the vehicle corresponding to the distinct vehicle operation scenario, identifying potential interactions among the modeled aspects respective of the corresponding states, and determining a candidate action that solves the model. Stated more simply, a SSOCEM 330 may include one or more models that are configured to determine one or more vehicle control actions for handling a scenario given a set of inputs. The models may include, but are not limited to, POMDP models, MDP models, Classical Planning (CP) models, Partially Observable Stochastic Game (POSG) models, Decentralized Partially Observable Markov Decision Process (Dec-POMDP) models, Reinforcement Learning (RL) models, artificial neural networks, hardcoded expert logic, or any other suitable types of models. Examples of different types of models are provided below. Each SSOCEM 330 includes computer-executable instructions that define a manner by which the models, e.g., decision process models, operate and a manner by which the models are utilized.

A SSOCEM 330 may implement a discrete time stochastic control process, such as a POMDP model, which may be a single-agent model that models a distinct vehicle operation scenario, which may include modeling uncertainty, using a set of states (S), a set of actions (A), a set of observations (Q), a set of state transition probabilities (T), a set of conditional observation probabilities (O), a reward function (R), or a combination thereof. A POMDP model may be defined or described as a tuple <S, A, Ω, T, O, R>.

A state from the set of states (S), may represent a distinct condition of respective defined aspects, such as external objects and traffic control devices, of the operational environment of the autonomous vehicle that may probabilistically affect the operation of the autonomous vehicle at a discrete temporal location. A respective set of states (S) may be defined for each distinct vehicle operation scenario. Each state (state space) from a set of states (S) may include one or more defined state factors. Although some examples of state factors for some models are described herein, a model, including any model described herein, may include any number, or cardinality, of state factors. Each state factor may represent a defined aspect of the respective scenario and may have a respective defined set of values. Although some examples of state factor values for some state factors are described herein, a state factor, including any state factor described herein, may include any number, or cardinality, of values.

For example, a remote or external object operating in the proximity of the vehicle may affect the operation of the vehicle and may be represented in a model. The model may include representing the following identified or expected information for the remote object, such as a remote vehicle: its geospatial location, its path, heading, or both, its velocity, its acceleration or deceleration rate, or a combination thereof corresponding to a respective temporal location. A respective set of states may be defined for each distinct vehicle operation scenario. At instantiation, the current state of the model may correspond to a contemporaneous state or condition of the operating environment.

An action from the set of actions (A) may indicate an available vehicle control action at each state in the set of states (S). A respective set of actions may be defined for each distinct vehicle operation scenario. Each action (action space) from a set of actions (A) may include one or more defined action factors. Although some examples of action factors for some models are described herein, a model, including any model described herein, may include any number, or cardinality, of action factors. Each action factor may represent an available vehicle control action and may have a respective defined set of values. Although some examples of action factor values for some action factors are described herein, an action factor, including any action factor described herein, may include any number, or cardinality, of values.

An observation from the set of observations (Ω) may indicate available observable, measurable, or determinable data for each state from the set of states (S). A respective set of observations may be defined for each distinct vehicle operation scenario. Each observation (observation space), from a set of observations (Ω) may include one or more defined observation factors. Although some examples of observation factors for some models are described herein, a model, including any model described herein, may include any number, or cardinality, of observation factors. Each observation factor may represent available observations and may have a respective defined set of values. Although some examples of observation factor values for some observation factors are described herein, an observation factor, including any observation factor described herein, may include any number, or cardinality, of values.

A state transition probability from the set of state transition probabilities (T) may probabilistically represent changes to the operational environment of the autonomous vehicle, as represented by the set of states (S), responsive to the actions of the autonomous vehicle, as represented by the set of actions (A), which may be expressed as T: S×A×S→[0, 1]. A respective set of state transition probabilities (T) may be defined for each distinct vehicle operation scenario. Although some examples of state transition probabilities for some models are described herein, a model, including any model described herein, may include any number, or cardinality, of state transition probabilities. For example, each combination of a state, an action, and a subsequent state may be associated with a respective state transition probability.

The set of state transition probabilities may be identified based on the operational environment data. For example, the operational environment data may indicate an area type, such as urban or rural, a time of day, an ambient light level, weather conditions, traffic conditions, which may include expected traffic conditions, such as rush hour conditions, event-related traffic congestion, or holiday related driver behavior conditions, road conditions, jurisdictional conditions, such as country, state, or municipality conditions, or any other condition or combination of conditions that may affect the operation of the vehicle.

Examples of state transition probabilities associated with a pedestrian vehicle operational scenario may include a defined probability of a pedestrian jaywalking (e.g., based on a geospatial distance between the pedestrian and the respective road segment); a defined probability of a pedestrian stopping in an intersection; a defined probability of a pedestrian crossing at a crosswalk; a defined probability of a pedestrian yielding to the vehicle at a crosswalk; any other probability associated with a pedestrian vehicle operational scenario.

Examples of state transition probabilities associated with an intersection vehicle operational scenario may include a defined probability of a remote vehicle arriving at an intersection; a defined probability of a remote vehicle cutting-off the autonomous vehicle; a defined probability of a remote vehicle traversing an intersection immediately subsequent to, and in close proximity to, a second remote vehicle traversing the intersection, such as in the absence of a right-of-way (piggybacking); a defined probability of a remote vehicle stopping, adjacent to the intersection, in accordance with a traffic control device, regulation, or other indication of right-of-way, prior to traversing the intersection; a defined probability of a remote vehicle traversing the intersection; a defined probability of a remote vehicle diverging from an expected path proximal to the intersection; a defined probability of a remote vehicle diverging from an expected right-of-way priority; or any other probability associated with an intersection vehicle operational scenario.

Examples of state transition probabilities associated with a lane change vehicle operational scenario may include a defined probability of a remote vehicle changing velocity, such as a defined probability of a remote vehicle behind the vehicle increasing velocity or a defined probability of a remote vehicle in front of the vehicle decreasing velocity; a defined probability of a remote vehicle in front of the vehicle changing lanes; a defined probability of a remote vehicle proximate to the vehicle changing speed to allow the vehicle to merge into a lane; or any other probabilities associated with a lane change vehicle operational scenario.

A conditional observation probability from the set of conditional observation probabilities (O) may represent probabilities of making respective observations (Ω) based on the operational environment of the vehicle, as represented by the set of states (S), responsive to the actions of the vehicle, as represented by the set of actions (A), which may be represented as O: A×S×Ω→[0, 1]. A respective set of conditional observation probabilities (O) may be defined for each distinct vehicle operation scenario. Although some examples of state conditional observation probabilities for some models are described herein, a model, including any model described herein, may include any number, or cardinality, of conditional observation probabilities. For example, each combination of an action, a subsequent state, and an observation may be associated with a respective conditional observation probability.

An example may be illustrated with reference to an intersection that the vehicle is approaching by traversing a first road. Contemporaneously, a remote vehicle may approach the intersection by traversing a second road. The vehicle may identify and evaluate operational environment data, such as sensor data, corresponding to the intersection, which may include operational environment data corresponding to the remote vehicle. The operational environment data may be inaccurate, incomplete, or erroneous. The vehicle may identify information probabilistically identifying the remote vehicle, such as probabilistically identifying location information for the remote vehicle. The conditional observation probability corresponding to observing, or probabilistically identifying, the location of the remote vehicle represents the probability that the identified operational environment information accurately represents the location of the remote vehicle. A model, including any model described herein, may include any number, or cardinality, of conditional observation probabilities. For example, each combination of an action, a subsequent state, and an observation may be associated with a respective conditional observation probability.

The reward function (R) may determine a respective positive or negative (cost) value that may be accrued for each combination of state and action, which may represent an expected value of the autonomous vehicle traversing the vehicle transportation network from the corresponding state in accordance with the corresponding vehicle control action to the subsequent state, which may be expressed as R: S×A→ [symbol] .

Solving a model may include determining a policy or solution, which may be a function, that maximizes the accrued reward, which may be determined by evaluating the possible combinations of the elements of the tuple, such as <S, A, Ω, T, O, R>, that defines the model. A policy or solution may identify or output a reward maximized, or optimal, candidate vehicle control action based on identified belief state data. The identified belief state data, which may be probabilistic, may indicate current state data, such as a current set of state values for the respective model, or a probability for the current set of state values, and may correspond with a respective relative temporal location. For example, solving a MDP model may include identifying a state from the set of states, identifying an action from the set of actions, determining a subsequent, or successor, state from the set of states subsequent to simulating the action subject to the state transition probabilities. Each state may be associated with a corresponding utility value, and solving the MDP model may include determining respective utility values corresponding to each possible combination of state, action, and subsequent state. The utility value of the subsequent state may be identified as the maximum identified utility value subject to a reward or penalty, which may be a discounted reward or penalty. The policy may indicate an action corresponding to the maximum utility value for a respective state. Solving a POMDP model is similar to solving the MDP model, except based probabilities for respective states and subject to observation probabilities corresponding generating observations for respective states. Where a probability is associated with a state within a POMDP model and other models that do not rely on discrete states, the states may be referred to as belief states. Thus, solving the SSOCEM model may include evaluating the possible state-action-state transitions and updating respective belief states, such as using Bayes' rule, particle filters, etc., based on respective actions and observations.

The autonomous vehicle operational management system 300 may include any number or combination of types of models. For example, the pedestrian-SSOCEM 331, the intersection-SSOCEM 332, the lane-change-SSOCEM 333, the merge-SSOCEM 334, and the pass-obstruction-SSOCEM 335 may be POMDP models. In another example, the pedestrian-SSOCEM 331 may be an MDP model and the intersection-SSOCEM 332 may be a POMDP model. The AVOMC 310 may instantiate any number of instances of the SSOCEMs 330 based on the operational environment data. A SSOCEM 336 is shown using broken lines to indicate that the autonomous vehicle operational management system 300 may include any number or additional types of SSOCEMs 330. Although not expressly shown, in some embodiments an operational environment monitor 320 may identify occlusions, may identify or determine a probability that an external object is occluded, or hidden, by an identified occlusion, and may include occluded vehicle probability information in one or more SSOCEMs 330.

One or more of the AVOMC 310, the operational environment monitors 320, or the SSOCEMs 330 may operate continuously or periodically, such as at a frequency of ten hertz (10 Hz). For example, the AVOMC 310 may identify a vehicle control action many times, such as ten times, per second. The operational frequency of each component of the autonomous vehicle operational management system 300 may be synchronized or unsynchronized, and the operational rate of one or more of the AVOMC 310, the operational environment monitors 320, or the SSOCEMs 330 may be independent of the operational rate of others.

As described above, precise control for every driving scenario is important. For autonomous vehicles, however, precise control becomes essential for dynamic scenes arising in densely populated and residential driving scenarios. Some examples include motion planning and tracking through tight U-turns, residential roads with parked, staggered cars, and sharing roads with cyclists and pedestrians. The task becomes more challenging when considering the varying vehicle dynamics under different road conditions and weather, sensor disparities, and actuator limitations. With noise arising from surrounding information and sensors, the unpredictability of road users, and limitations on vehicle actuators, precise control aims to make split-second proactive and reactive decisions based on the data it receives to maneuver through complex scenes while ensuring the safety and comfort of both passengers and other road users.

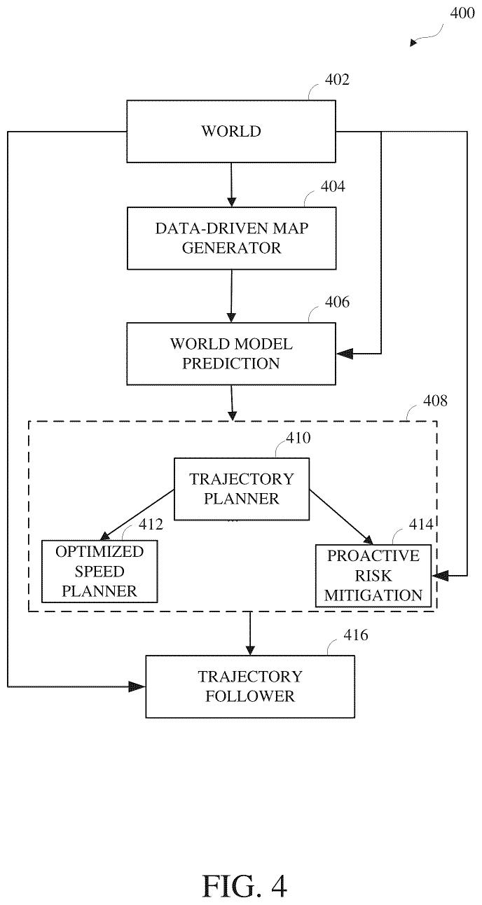

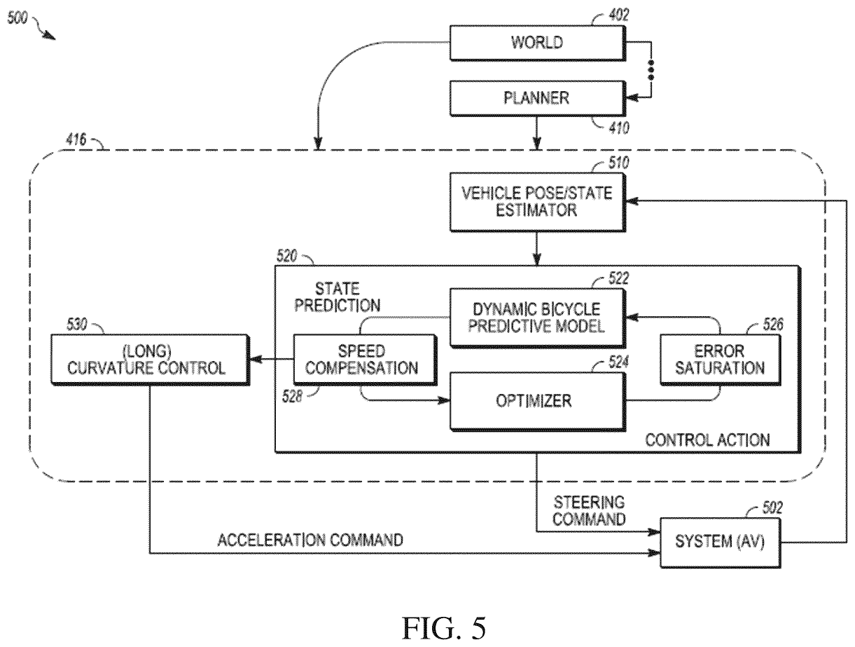

FIG. 4 is a diagram of a data pipeline 400 of a vehicle decision-making system. The vehicle decision-making system implements precise control using a trajectory follower 416, discussed in more detail in below starting with FIG. 5. As shown in FIG. 4, the world stage 402 represents a perception system of the autonomous vehicle (AV), such as the autonomous vehicle 100, that includes information regarding the scene (e.g., a vehicle transportation network) through which the AV is traversing.

The world stage 402 can include or receive map data. The map data comprises any map data representative of the operational environment about the AV, including the vehicle transportation network. The map data 404 may include high-definition (HD) map data, standard definition (SD) map data, or some combination of HD map data and SD map data. For example, some areas of the operational environment may be represented by HD map data, while others are represented by SD map data.

The world stage 402 can receive raw perception data from sensors of the AV, such as the sensor 136. The sensors 136 include a camera (e.g., an image camera), light detection and ranging (LiDAR), a global positioning system (GPS) sensor or unit, or any other sensor or combination of sensors that images, captures, identifies, or otherwise detects the operational environment, including other road users, buildings, etc., around the AV. The world stage 402 can receive data from other sources, such as from fixed infrastructure cameras, other vehicles within the vehicle transportation system, a remote vehicle support system, etc., through wired and wireless signal links described above with reference to FIG. 2.

The data-driven map generator 404 can perform object association. For example, object association can include determining objects from the received signals of the world stage 402. Object association may associate location information within each of the signals with a respective road object, e.g., a vehicle, a pedestrian or non-motorized vehicle, etc., within the vehicle transportation network. The data-driven map generator 404 may identify and locate static objects within the map data and may generate or maintain a state for at least some of the determined objects, such as a velocity (when an object is a dynamic object and not a static object), a pose, a geometry (such as width, height, and depth), a classification (e.g., bicycle, large truck, pedestrian, road sign, etc.), a lane location, or some combination thereof.

The data-driven map generator 404 can output this information to a world model prediction stage 406. The world model prediction stage 406 may receive the sensed objects over time from the data-driven map generator 404 and, where applicable, the world stage 402. Using data such as the location, and heading and velocity information where available, sensed objects may be fused where appropriate. That is, the data associated with each object may be compared to determine whether respective objects identified by separate sources (e.g., from separate signals input to the data-driven map generator 404) may be the same object. Any technique for comparing the data of each sensed object may be used. The more similar the data is, the more likely two objects are the same. The data of the objects determined to be the same object are fused to generate an object, including predictions for a tracked object at positions over time (e.g., a fused trajectory). The world model prediction stage 406 can output this object information, including separately tracked objects with a respective trajectory for use in decision making of the AV in the decision-making component 408. The world model prediction stage 406 can output localization information, e.g., the position of objects relative to roads and/or lanes in the vehicle transportation network, to the decision-making component 408.

In some implementations, some or all the above components can correspond to component(s) of the autonomous vehicle operational management system 300. In an example, the world model prediction stage 406 corresponds to an operational environment monitor 320. The world stage 402 and the data-driven map generator 404 may be part of an operational environment monitor 320 or more likely may be otherwise incorporated elsewhere, such as stored at least in part in memory 134 of the vehicle 100 and/or received remotely from the communication unit 132 and controlled by a processor, such as the processor 133.

The decision-making component 408 recommends an action (e.g., a candidate vehicle control action) for the AV, such as GO, YIELD/EDGE, or STOP. The action may be performed automatically by the AV. For example, the action may be performed by a processor of the AV, such as the processor 133, controlling one or more control systems of the AV, such as those controlling the brakes, acceleration (e.g., an accelerator pedal), steering (e.g., a steering wheel), etc., of the AV. The action may be performed by an ADAS in some implementations. The decision-making component 408 can correspond to components of the autonomous vehicle operational management system 300. In an example, the decision-making component 408 corresponds to a model of an SSOCEM 330. Accordingly, more than one decision-making component 408 may be used in implementations of the teachings herein. Outputs (e.g., candidate actions) from respective decision-making components 408 may be used to select a control action for the AV, such as doing the selection using the AVOMC 310 described previously.

In some implementations, the decision-making component 408 is or incorporates the functions of the AVOMC 310 described previously. That is, the decision-making component can select a control action for the AV using, for example, a trajectory planner 410. The trajectory planner 410 may be implemented by any known technique. In some implementations, the trajectory planner 410 uses a unicycle model. Whatever technique is used the trajectory planner 410 can output a sequence of control actions according to an optimized speed planner 412 and a proactive risk mitigation stage 414. The sequence may also be referred to as a plan, where the plan includes at least a planned path (e.g., a series of waypoints) and a speed plan (e.g., for the series of waypoints) that avoids obstacles and other road users (ORUs) based on the predictions proactively, e.g., by applying brakes and desired path offsets.

Although shown as single components of the data pipeline 400, at least some components may be duplicated (e.g., because multiple scenarios are indicated by the detected objects). For example, a single world model prediction stage 406 may be used for all operational environment monitors 320, while a respective data-driven map generator 404 (e.g., each associated with an object within a scenario) may be used for each operational environment monitor 320. Other variations are possible. Moreover, although the components of the data pipeline 400 are described as having respective functions, the functions may be distributed differently and/or one or more components may be combined.

Control of an AV is challenging due to the complex interplay between vehicle dynamics, environmental uncertainties, and computational constraints. Accordingly, the trajectory follower 416 has the goal of implementing precise control that allows the AV to adjust the proactive planned path and react to surroundings in a more timely manner to avoid collisions with obstacles. More specifically, the trajectory follower 416 receives the plan from the trajectory planner 410 executes the plan by performing an optimization operation to revise the plan, wherein the optimization operation jointly minimizes a distance from the autonomous vehicle to at least one boundary or obstacle and a lateral and heading error as compared to the planned path as discussed in more detail below. The trajectory follower 416 thus follows a path while reacting to intrusions appearing on the road by re-planning and/or reactive steering. In some implementations, the trajectory follower 416 is a high fidelity model.

FIG. 5 is a diagram of a vehicle control system 500 incorporating the vehicle data pipeline 400 of FIG. 4. In FIG. 5, a data pipeline of an example of the trajectory follower 416 is also shown, as is a representation of an AV control system 502. The trajectory follower 416 uses dynamic model predictive control (MPC) for precise control of an autonomous vehicle as next described.

In this implementation, inputs into the trajectory follower 416 include non-drivable points (e.g., areas blocked by static objects) received from the world stage 402, a plan including a planned path and a speed plan and optionally boundaries received from the trajectory planner 410, and the vehicle poses over a multiple time points up to the current time (t₀, t₋₁, t₋₂, . . . ) received from the AV control system 502 described in additional detail below. The total amount of time included covers a defined time period, also called a prediction horizon. In some implementations, the prediction horizon is around 1 to 5 seconds. Where the trajectory follower 416 is running at 100 hz, a (e.g., steering) command as described in more detail below is generated every 0.01 seconds. The plan may be referred to as a reference plan, the planned path, a reference path, and the speed plan as a reference speed plan comprising reference speeds.

The (e.g., lateral) MPC 520 includes a predictive model 522 and an optimizer stage 524. In this example, the predictive model 522 incorporates a dynamic bicycle predictive model, so the MPC 520 may be considered a dynamic bicycle model based MPC. The dynamic bicycle model estimates future vehicle states in consideration of the dynamic capabilities of the car and accounts for a nonlinear tire model and parameters to interpret limits of vehicle. That is, where the current state at time 0 is represented by equation (1), a subsequent state at time k+1 is determined by equation (2) where k is the current time through a prediction horizon N.

$${X}_{0} = {[ {β}_{0} {γ}_{0} {Δψ}_{0} {e}_{0} ]}^{T} \qquad ( 1 )$$

$${X}_{k + 1} = [ \begin{matrix}{β}_{k} \\ {γ}_{k} \\ Δ {ψ}_{k} \\ {e}_{k}\end{matrix} ] = {A}_{k} {X}_{k} + {B}_{1 k} {F}_{yfk} + {B}_{3 k} \qquad ( 2 )$$

In the above, the vehicle state variables β, γ, Δψ, and e are used, where:
β represents the side slip angle (e.g., in radians);
γ represents the yaw rate (e.g., in radians per second);
Δψ represents the heading error; and
e represents the lateral error.

Further, Aₖ, B₁ₖ, and B₃ₖ are matrices where:

$${A}_{k} = [ \begin{matrix}\frac{{\overline{C}}_{αγ}}{m {V}_{x}} & \frac{- b {\overline{C}}_{αγ}}{m {V}_{x}^{2}} - 1 & 0 & 0 \\ \frac{- b {\overline{C}}_{αγ}}{{I}_{Z}} & \frac{{b}^{2} {\overline{C}}_{αγ}}{{I}_{Z} {V}_{x}} & 0 & 0 \\ 0 & 1 & 0 & 0 \\ {V}_{x} & 0 & {V}_{x} & 0\end{matrix} ] ;$$

$${B}_{1} = [ \begin{matrix}\frac{1}{m {V}_{x}} \\ \frac{α}{{I}_{Z}} \\ 0 \\ 0\end{matrix} ] ; and$$

$${B}_{3} = [ \begin{matrix}0 \\ 0 \\ \frac{- k {V}_{x}}{1 - K \overline{e}} \\ 0\end{matrix} ] .$$

A nonlinear tire model based on parabolic normal force distribution is used to estimate cornering stiffness of the car according to the following.

$${\overline{C}}_{αγ} = μ {F}_{Z} [ 3 {θsec}^{2} ( α ) - 6 {θ}^{2} {sec}^{2} ( α ) tan ( α ) sgn ( tan ( α ) ) + 3 {θ}^{3} {sec}^{2} ( α ) {tan}^{2} ( α ) ]$$

In the above, the following vehicle parameters are used.

Inertia is represented by I_{z} (e.g., in kilograms).

Speed is represented by Vₓ (e.g., in meters per second).

Cornering stiffness is represented by C̅_{αγ}.

Road friction is represented by μ.

Normal force is represented by F_{z}.

Tire slip angle is represented by α (e.g., in radians).

In equation (2), F_{yk} is the front lateral force of the AV (e.g., in Newtons), which is converted back to steering command using, for example, an experimental look-up table.

The MPC states are measured (estimated) from a vehicle control point (e.g., the center of mass). The lateral offset constraint (i.e., the distance to left and right boundaries) is set to avoid collision laterally at the vehicle control point, and the heading (angle) constraint is calculated from the vehicle rear axle considering the AV width to avoid collision from rear corners of the AV.

The optimizer stage 524 receives the state variables and the front lateral force F_{y} and uses them to perform an optimization operation to revise the plan. The optimization operation jointly minimizes a lateral and heading error as compared to the planned (e.g., target) path while applying each of the lateral offset constraint Hₗₐₜₑᵣₐₗ and the heading (angle) constraint H_{heading} as soft constraints. The soft constraints are represented by respective slack variables, and a penalty applied to at least one of the slack variables is greater than a penalty applied to the lateral and heading error to prioritize collision avoidance over maintaining the planned path. Stated elsewise, tracking constraints and collision avoidance constraints are combined to maximize path following while using reactive control responsive to a changing AV environment. The reactive control prioritizes the collision avoidance such that the planned path may be replanned. An example of the optimization operation for the prediction horizon N is shown below as equation (3).

$$min {\sum }_{k = 1}^{N} [ {x}^{T} ( k ) Q ( k ) x ( k ) + Δ {F}_{yf}^{T} ( k ) R ( k ) Δ {F}_{y f} ( k ) + {S}_{lateral} ( k ) {W}_{lateral} ( k ) + {S}_{heading} ( k ) {W}_{heading} ( k ) \qquad ( 3 )$$

As can be seen from equation (3), the optimization operation implements a cost function that has three terms and is minimized. The first term represents a path tracking error where x represents the state variables [γ, β, Δψ, e], and Q(k) is a tunable penalty. The second term represents a steering maneuver smoothness where ΔF_{yf} is the front lateral force, and R(k) is a tunable penalty. Either alone or in combination, the first and second terms may be referred to as tracking constraints. The third term is a collision avoidance constraint that relates to/involves slack variables used in constraints of distance (e.g., lateral offset and heading constraints) to a boundary and/or an obstacle where S is a slack variable, and W(k) is a tunable penalty. That is, distance is not directly used in the objective function, which instead includes slack variables to make the inequality constraints described below with regards to equations (soft constraints. As is known, a slack variable defines an allowance to violate a constraint and should have a value near 0. Each of the tunable penalties Wₗₐₜₑᵣₐₗ(k) and W_{heading}(k) is set greater than the tunable penalties Q(k) and R(k) to achieve path re-planning in tight scenes and/or reactive scenarios.

The solution to equation (3) has certain hard constraints for predictive control, which are described as follows.

An initial condition x(0)=xᵢₙ ensures that a future prediction is based on the current states.

State boundaries xₘᵢₙ≤x≤xₘₐₓ ensure vehicle stability by constraining yaw rate and side slip angle.

Equality constraints based on vehicle dynamics x(k+1)=A(k)x(k)+B₁(k)F_{yf}(k)+B₃(k) for k=1, . . . , N ensure that the output of the optimization operation is physically achievable for the AV.

An input limit |F_{yf}(k)|≤F_{yf,max}(k) for k=0, . . . , N ensures that no steering request is over the steering lock (e.g., a maximum steering offset from center).

A slew rate limit |ΔF_{yf}(k)|≤ΔF_{yf,max}(k) for k=0, . . . , N ensures that no steering request is over the steering rate limitation (e.g., a maximum change in the steering position from one time point to another).

The solution for equation (3) has certain soft constraints with slack variables for reactive control, which are described as follows.

Environmental constraints on a lateral offset Hₗₐₜₑᵣₐₗ(k)x(k)≤(Gₗₐₜₑᵣₐₗ(k)+Sₗₐₜₑᵣₐₗ(k)) for k=1, . . . , N ensure that the AV stays within left and right boundaries. In this inequality constraint, the following variables are used.

$${H}_{lateral} = [ \begin{matrix}0 & 0 & 0 & 1 \\ 0 & 0 & 0 & - 1\end{matrix} ]$$

$${G}_{lateral} = [ \begin{matrix}{e}_{kmax} \\ {e}_{kmin}\end{matrix} ]$$

Further, eₖₘₐₓ and eₖₘᵢₙ are determined based on boundary information given by the planner and the direct information from the perception system of surrounding objects. Sₗₐₜₑᵣₐₗ is the slack variable for lateral boundaries that is solved for and is used in equation (3).

Environmental constraints on a heading angle H_{heading}(k)x(k)≤(G_{heading}(k)+S_{heading}(k)) for k=1, . . . , N ensure that the AV heading is toward a path without a colliding obstacle present. In this inequality constraint, the following variables are used.

$${H}_{heading} = [ \begin{matrix}0 & 0 & 0 & 1 \\ 0 & 0 & 0 & - 1\end{matrix} ]$$

$${G}_{heading} = [ \begin{matrix}Δ {ψ}_{{k}_{max}} \\ Δ {ψ}_{{k}_{min}}\end{matrix} ]$$

Further, Δψₖ_{ₘₐₓ} and Δψₖ_{ₘᵢₙ} are determined based on boundary information given by the planner and the direct information from the perception system of surrounding objects. S_{heading} is the slack variable for heading angle constraint that is solved for and is used in equation (3).

In the optimization operation of equation (3), the first and second terms, namely the path tracking error and the steering maneuver smoothness, are tracking terms that achieve path following by minimizing lateral and heading error to the planned path. The third term is a collision avoidance term. That is, the third term involves the slack variables used to relax the collision constraints and the penalizing weights associated with these slack variables, which characterize the goal of collision avoidance. The constraints on lateral offset and heading angle together ensure a collision-free path with the AV staying within left and right boundaries.

A large penalty on the slack variables can be set to prioritize collision avoidance over tracking performance, which generally leads to path re-planning. Stated otherwise, the slack variables are included in the objective function (equation (3)) and may be set with high penalty to ensure that the inequality constraints are soft constraints but with higher priority to achieve (rather than the first and second terms for tracking and smoothness) when there are near surrounding obstacles).

Solving the optimization problem provides the best solution to keep the AV within boundaries (constraints) and maintain stability while minimizing deviation from the desired (planned) path. The output from the optimizer stage 524 can be used to issue steering commands to the AV control system 502.

It is desirable to prevent aggressive steering correction when the AV is to rejoin the planned path. Equation (3) reduces error terms, but it can result in aggressive steering when error states increase. Once the lateral error and the heading error the current and desired states of the AV are above a threshold, the error states can be saturated in the predictive model 522. In this way, the optimized steering maneuver from the optimizer stage 524 compensates with a gradual correction instead of aggressive steering. This function, also referred to as anti-wind up, can be performed by the error saturation stage 526. This ensures vehicle stability and the comfort of passengers when deviating from desired (planned) path (e.g., recovering from a reactive maneuver).

However, even where the lateral error and heading error would result in aggressive steering, it is desirable to avoid error state saturation at times. Accordingly, saturation may be enabled only under certain scenarios. For example, larger heading and lateral errors result on curves, so saturation may be enabled when the curvature of the path is less than a minimum threshold. This allows oscillations to be avoided on a straight road. In another example, saturation is enabled when the speed is higher than a maximum threshold. This prevents instability at high speed with a large steering angle. Also, saturation may not be allowed in reactive situations where aggressive steering might be needed.

The vehicle states used for the optimization operation of equation (3) include the slip angle β and the yaw rate γ. These states may be used as raw values from the AV control system 502 to the MPC 520. However, steering oscillation is observed, especially at low speed due to noisy measurement inputs from sensors. Accordingly, the teachings herein may use these inputs to a vehicle pose/state estimator stage 510 to implement a virtual sensor (also called an observer) for both yaw rate and vehicle side slip angle estimation. These observers can produce a more accurate vehicle estimation of these vehicle states.

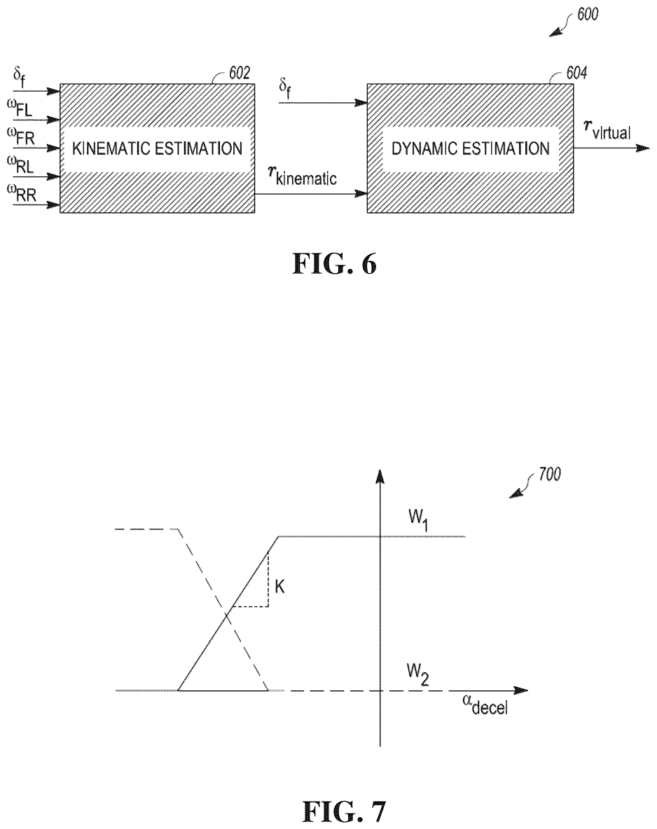

FIG. 6 is a diagram of an observer 600 used for yaw rate estimation. The observer 600 may be implemented as hardware, software, or some combination thereof in the vehicle pose/state estimator 510. The observer 600 has two stages—a kinematic estimation stage 602 and a dynamic estimation stage 604. In brief, the kinematic estimation stage 602 receives wheel speed (e.g., wheel speed ω_{FL} of the front, left wheel, wheel speed ω_{FR} of the front, right wheel, wheel speed ω_{RL} of the rear, left wheel, and wheel speed ω_{RR} of the rear, right wheel) and acceleration δ_{f} from the controller area network (CAN) bus of the AV to estimate a kinematic yaw rate γ_{kinematic} using a kinematic relation v=γω that addresses differential wheel speed. More specifically, in the following examples, the kinematic estimation stage 602 considers the longitudinal slip ratio because that value indicates how much the wheel slips relative to the ground, which affects the vehicle force and hence the yaw rate especially during braking and sudden acceleration, but other techniques for kinematic estimation of the yaw rate are possible. The dynamic estimation stage 604 uses the kinematic yaw rate γ_{kinematic} and the acceleration δ_{f} to filter sensor noise to produce a virtual (or filtered) yaw rate γᵥᵢᵣₜᵤₐₗ. In the following examples, the dynamic estimation stage 604 filters sensor noise using a Kalman filter with a linear bicycle model, but this is not required. Any filtering means may be used.

To determine the filtered yaw rate γᵥᵢᵣₜᵤₐᵢ, separate estimations are determined assuming whether the AV is braking and whether the AV is suddenly accelerating. A weighted average of estimations assuming a nonzero tire slip and a zero tire slip when the AV decelerates prevents a large yaw rate estimation due to slip angle inaccuracy.

The vehicle pose/state estimator stage 510 uses a first model that assumes the AV is braking. Namely, the slip S_{FR} of the front, right tire is determined according to equation (4), and the slip S_{FL} of the front, left tire is determined according to equation (5).

$${S}_{FR} = \frac{{ω}_{FR} R - [ V + ( \frac{{l}_{width}}{2} ) cos ( {δ}_{f} ) {γ}_{prev} ]}{V + ( \frac{{l}_{width}}{2} ) cos ( {δ}_{f} ) {γ}_{prev}} \qquad ( 4 )$$

$${S}_{FL} = \frac{{ω}_{FL} R - [ V - ( \frac{{l}_{width}}{2} ) cos ( {δ}_{f} ) {γ}_{prev} ]}{V - ( \frac{{l}_{width}}{2} ) cos ( {δ}_{f} ) {γ}_{prev}} \qquad ( 5 )$$

In these equations, R is vehicle tire radius, V is the velocity of the AV, l_{width} is the width of the AV, and γₚᵣₑᵥ is the previously determined yaw rate γᵥᵢᵣₜᵤₐₗ, that is, the filtered yaw rate γᵥᵢᵣₜᵤₐₗ determined at the last time point.

Thus, the yaw rate γ under these assumptions is determined according to equation (6).

$$γ = \frac{{γ}_{p r e v} - [ V ( {S}_{FR} - {S}_{FL} ) / ( {l}_{width} cos ( {δ}_{f} ) ) ]}{1 + ( \frac{{S}_{FR} + {S}_{FL}}{2} )} \qquad ( 6 )$$

In contrast, when it is assumed that the AV is not braking, acceleration is considered. More specifically, acceleration is compared to a threshold to determine whether the acceleration is sudden or not. In an example, a change in longitudinal acceleration (also called acceleration jerk) above 0.5 m/s³ is considered to be sudden acceleration. Where it is assumed that there is no sudden acceleration, a second model determines the yaw rate γ under these assumptions according to equation (7).

$$γ = \frac{{ω}_{F R} R - {ω}_{F L} R}{{l}_{width}} \qquad ( 7 )$$

Where it is assumed that there is sudden acceleration, a third model determines the slip S_{FR} of the front, right tire according to equation (8) and the slip S_{FL} of the front, left tire according to equation (9).

$${S}_{F R} = \frac{{ω}_{F R} R - [ V + ( \frac{{l}_{width}}{2} ) cos ( {δ}_{f} ) {γ}_{p r e v} ]}{{ω}_{F R} R} \qquad ( 8 )$$

$${S}_{F L} = \frac{{ω}_{F L} R - [ V - ( \frac{{l}_{width}}{2} ) cos ( {δ}_{f} ) {γ}_{p r e v} ]}{{ω}_{F L} R} \qquad ( 9 )$$

Thus, the yaw rate γ under these assumptions is determined according to equation (10).

$$γ = \frac{{γ}_{p r e v} - [ V ( {S}_{F R} - {S}_{F L} ) / ( {l}_{width} cos ( {δ}_{f} ) ) ]}{1 + ( \frac{{S}_{F R} + {S}_{F L}}{2} )} \qquad ( 10 )$$

As mentioned previously, a weighted average of estimations assuming a nonzero tire slip and a zero tire slip when the AV decelerates prevents a large yaw rate estimation due to slip angle inaccuracy. More specifically, when the AV decelerates, either due to braking or to not accelerating, equation (7) is weighted by a weight w₂, and equation (6) is weighted by a weight w₁. The yaw rate γᵥᵢᵣₜᵤₐₗ is thus equal to the weight w₂ times the yaw rate resulting from equation (7) and the weight w₁ times the yaw rate resulting from equation (6).

FIG. 7 is a graph of deceleration as compared to the weights w₁ and w₂. The following equations apply.

$${w}_{1} = k \times {a}_{decel} + b \qquad ( 11 )$$

$${w}_{2} = 1 - {w}_{1} \qquad ( 12 )$$

$${w}_{1} , {w}_{2} ∈ [ 0 , 1 ] \qquad ( 13 )$$

In equation (11), k represents the slope of the linear relationship between a_{decel} and w₁. The slope indicates the reliability of the yaw rate assuming nonzero slip angle as more deceleration is observed (e.g., where a_{decel}<0). In some implementations, k=0.25. As can be seen by reference to FIG. 7, the weight w₁ of the nonzero slip estimation increases when deceleration a_{decel} increases. In equation (11), b defines a threshold where any value of a_{decel} above −b/k (e.g., in m/s²) is considered as having no slip. Hence, w₁=0, which means the yaw rate is estimated by assuming no longitudinal slip angle on the tire. In some implementations, b=−0.5. Both b and k are tunable parameters.

As mentioned above, the vehicle state slip angle β used for the optimization operation of equation (3) may also be estimated using a virtual sensor (also called an observer) implemented at the vehicle pose/state estimator stage 510 to address steering oscillation observed at, for example, low speeds due to noisy measurement inputs from sensors. In addition, understeering can result during low-speed tight turns.

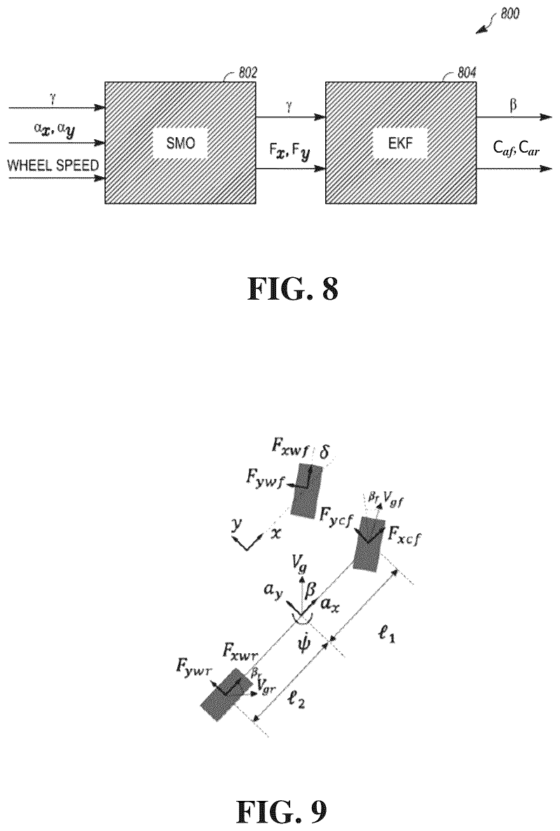

FIG. 8 is a diagram of an observer 800 used for slip angle estimation. The observer 800 may be implemented as hardware, software, or some combination thereof in the vehicle pose/state estimator 510. The observer 800 has two stages-a sliding mode observer (SMO) stage 802 and a filtering stage 804 that, in this example, includes an extended Kalman filter (EKF). In brief, the observer 800 uses a sliding mode observer with a tire force model to estimate side slip angle and applies a Kalman filter with a dynamic model to ensure smoothness of the output. Cornering stiffness is also estimated as part of the process.

In more detail, the sliding mode observer (SMO) stage 802 estimates tire force, here the longitudinal force Fₓ and the lateral force F_{y}, using a single track bicycle model according to equation (14) and a force model according to equation (15).

$$\ddot{ψ} = \frac{1}{{I}_{Z}} [ {L}_{1} {F}_{yf , car} - {L}_{2} {F}_{y f} ] \qquad ( 14 )$$

$$\dot{{F}_{ycf}} = 0 ; \qquad ( 15 )$$

$$\dot{{F}_{ywr}} = 0 ;$$

$$\dot{{F}_{xcf}} = 0 ;$$

$${a}_{x} = \frac{{F}_{xcf}}{m} ; and$$

$${a}_{y} = \frac{{F}_{ycf} + {F}_{ywr}}{m} .$$

Parameters (variables) used in the estimations by the observer 800 are shown in FIG. 9 and are listed below.

Yaw rate is represented by ψ.

Acceleration is represented by a.

Steering angle is represented by δ.

Vehicle speed is represented by V_{g}.

Side slip angle is represented by β.

Tire force is represented by F.

Track length is represented by l.

Vehicle mass is represented by m.

A sliding mode observer is used because it is robust to disturbances and uncertainties. Within the sliding mode observer, a continuous approximation of sign function may be used to reduce chattering. An example of a sign function that may be used is shown below.

$$sign ( x ) = \frac{x}{\sqrt{{x}^{2} + {ε}^{2}}}$$

In the foregoing, x is an input variable and E is a tunable parameter chosen to preserve smoothness. Herein, x are the states used in the state model as in equations (14) and (15). In some implementations, the value of E is selected as 5.

The output of the SMO stage 802 is a longitudinal force Fₓ and a lateral force F_{y} provided to the filtering stage 804. The filtering stage 804 incorporates a side slip angle model and a linear adaptive tire force model that corrects cornering stiffness error.

The side slip angle model is a single track model where tire slip is determined according to equation (16) and wheel slip is determined according to equation (17).

$$tire slip \dot{β} = \frac{1}{m {V}_{g}} [ {F}_{xwf} sin ( δ - β ) + {F}_{ywf} cos ( δ - β ) + {F}_{y w r} cos ( β ) ] - \dot{ψ} \qquad ( 16 )$$

$$wheel slip {β}_{f} = ( δ - β - \frac{{l}_{1} \dot{ψ}}{{V}_{g}} ) and {β}_{γ} = ( - β + \frac{{l}_{2} \dot{ψ}}{{V}_{g}} ) \qquad ( 17 )$$

The tire force model is represented by equation (18).

$$tire force {F}_{ywi} W ( {β}_{i} ) = ( {C}_{a i} + Δ {C}_{a i} ) {β}_{i} \qquad ( 18 )$$

In equation (18), i=f(front), r(rear), C_{αi} is a cornering stiffness, and ΔC_{αi} is a cornering stiffness adjustment.

Referring again to FIG. 5, an output of the predictive model 522 includes state predictions for the optimizer stage 524 as discussed previously. However, the MPC 520 of the trajectory follower 416 can include a speed compensation stage 528 that updates the speed profile under certain circumstances before input to the optimizer stage 524.

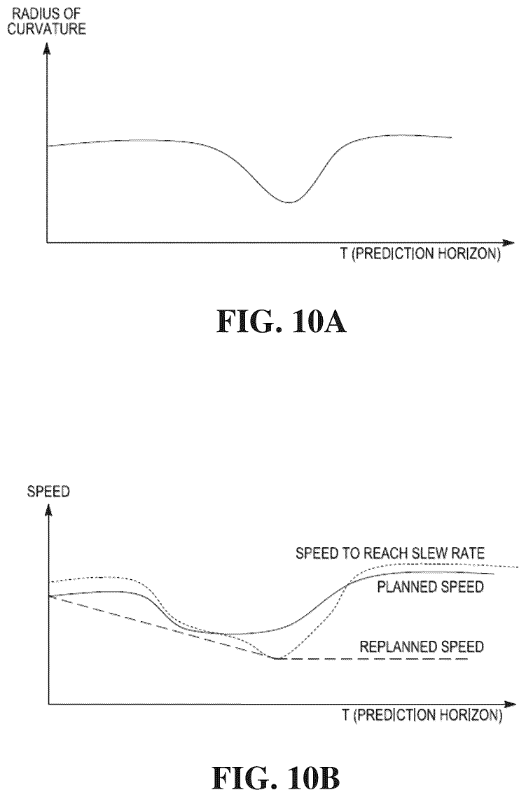

More specifically, a maximum rate of change in the steering angle for a vehicle (also called a slew rate limit) is restricted and depends on the vehicle speed. This is an actuator limitation where a lower steering rate is available at higher speed to maintain stability of vehicle motion. The speed compensation stage 528 implements a speed reduction algorithm that allows faster steering on tight turns to prevent understeering. Inputs include the planned speed over the prediction horizon of the follower 416 and the curvature of the path. Referring to the example of FIG. 10A, the radius of curvature of a path is graphed over time. FIG. 10B shows the planned speed over time (e.g., the speed profile) for the path in FIG. 10A. If the slew rate limit is reached at any point within the prediction horizon, the speed compensation stage 528 adjusts the planned speed. For example, the speed is re-planned with a constant deceleration profile based on a minimum required speed. Speed and curvature based tuning parameters may be used to provide smoother maneuver commands, e.g., using look up tables. The speed to meet the slew rate limit (from a look up table “speedBasedSlewRateLookup”) is also shown in FIG. 10 and is described below.

One example of code that can implement the speed compensation stage 528 follows.

```
minSpeed = DBL_MAX // initialize desired minimum speed minSpeed in prediction horizon
minSpeedIdx = N_{prediction} // initialize time step to reach desired speed
speedReplan = false // flag that indicates if speed reduction is required
for i = 0 to N_{prediction} // find desired minSpeed within prediction horizon
  desiredSlewRate = v_{planned}[i] * k_{planned}[i] * K_{tunable} // simplified kinematic
    relation
  slewRateLimit = speedBasedSlewRateLookup(v_{planned}[i]) // speed based slew
    rate lookup table
  if fabs(desiredSlewRate ) > slewRateLimit
    desiredSpeed = rev_speedBasedSlewRateLookup(k_{desired}[i])
      if desiredSpeed < minSpeed
    minSpeed = desiredSpeed
    minSpeedIdx = i
    speedReplan = true
if speedReplan == true // update speed profile with desired speed
  desiredDecel = (minSpeed − v_{curr})/t[minSpeedIdx] // assuming constant
    deceleration speed profile
  for i = 0 to N_{prediction}
      v_{planned}[i] = minSpeed
      if i < minSpeedIdx
        v_{planned}[i] = v_{curr} + desiredDecel * Δt
```

In the foregoing, N is the number of prediction steps in the horizon, v is the vehicle speed, k is the curvature, and K is a tunable parameter. In this way, the speed compensation stage 528 dynamically adjusts the speed command to keep the steering rate within slew rate limits to maintain control precision and vehicle stability.

In brief, the code operates as follows. The look up table speedBasedSlewRateLookup allows looking up a slew rate limit slewRateLimit according the original planned speed. Given the planned speed v_{planned} and desired path curvature k_{planned}, the desired slew rate desiredSlewRate is compared to the slew rate limit slewRateLimit obtained through the lookup table speedBasedSlewRateLookup. If any violation of slew rate is observed, the look up table is reversed (rev_speedBasedSlewRateLookup) using the kinematic relation described above (e.g., slew rate=speed*curvature*K_{tunable}) to look up the desired speed desiredSpeed based on the slew rate limit slewRateLimit. This will then be the new planned speed to satisfy path tracking and steering slew rate limit.

The output of the speed compensation stage 528, e.g., the speed profile whether updated or not, is provided to the optimizer stage 524 and to a (long) curvature control stage 530. In general, the precise control described herein is implemented/applied mainly for lateral control. The curvature control stage 530 may be incorporated to issue acceleration commands to the AV control system 502 to meet the speed profile. The curvature control stage 530 can be an existing controller used as a longitudinal controller in the vehicle. An existing curvature control algorithm is implemented as a non-constrained controller and does not utilize the concept of prediction horizon. Here, it may be integrated with the precise control to compute acceleration commands based on the speed profile and optimized steering commands.

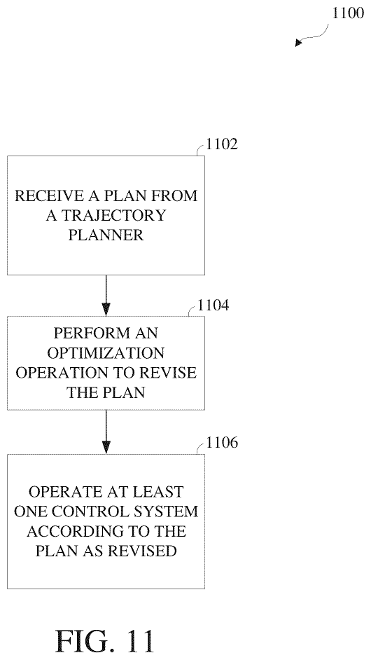

FIG. 11 is a flow chart of a method 1100 for precise control of an autonomous vehicle using a trajectory follower, such as the trajectory follower 416 described herein. The method 1100 may be performed by hardware, software, or some combination thereof.

At operation 1102, the trajectory follower receives a plan from a trajectory planner. The plan includes a planned path and a speed plan for the autonomous vehicle to traverse through a portion of a vehicle transportation network.

At operation 1104, the trajectory follower performs an optimization operation to revise the plan. In some implementations, the optimization operation jointly minimizes a lateral and heading error as compared to the planned path. Each of a lateral offset constraint and a heading angle constraint are applied as soft constraints. The soft constraints are represented by respective slack variables, and a penalty applied to at least one of the slack variables is greater than a penalty applied to the lateral and heading error to prioritize collision avoidance over maintaining the planned path. In other words, collision avoidance is addressed by applying the soft constraints and is prioritized by setting a relatively large penalty thereto. This results, under at least some environmental conditions, in revising (replanning, changing, modifying) the planned path within a prediction horizon.

At operation 1106, the trajectory follower operates at least one control system according to the plan as revised. The control system can be a steering system, a braking system, etc.

The precise control described herein allows an AV to adjust a proactive planned path and to promote timely obstacle avoidance in reactive scenarios. The precise control handles constraints in that the design takes both reference path tracking and environment boundaries (lane boundaries and obstacles) into consideration to generate an optimal solution to keep the AV, including front/rear/longitudinal edges, within safe operational boundaries while minimizing deviations from the desired (original planned) path. Including pose estimation can compensate for measurement errors and actuator limitations when integrating on platforms with different sensors and actuators and can be used to control an AV in various scenes and road conditions, such as tight curves or low friction road surfaces, by adjusting speed and with steering maneuvers. The system ensures precision and stability of path tracking with its predictive nature, which is further improved when the anti-wind up mechanism described herein is incorporated.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. An apparatus for controlling an autonomous vehicle, the apparatus comprising:
a processor configured to:
receive, from a trajectory planner, a plan comprising a planned path and a speed plan for the autonomous vehicle to traverse through a portion of a vehicle transportation network;
perform an optimization operation to revise the plan, wherein the optimization operation jointly minimizes a lateral and heading error as compared to the planned path while applying each of a lateral offset constraint and a heading angle constraint as soft constraints, wherein the soft constraints are represented by respective slack variables, and a penalty is applied to at least one of the slack variables that is greater than a penalty applied to the lateral and heading error to prioritize collision avoidance over maintaining the planned path; and
operate at least one control system of the autonomous vehicle according to the plan as revised.

2. The apparatus of claim 1, wherein the processor is configured to determine the lateral and heading error using state variables generated using a dynamic bicycle predictive model.

3. The apparatus of claim 2, wherein the state variables include a side slip angle, a yaw rate, a heading error, and a lateral error, and wherein the yaw rate is an estimated yaw rate that varies according to a longitudinal slip ratio.

4. The apparatus of claim 3, wherein the processor is configured to determine the side slip angle using the yaw rate as input to a sliding mode observer and a linear adaptive tire force model.

5. The apparatus of claim 2, wherein the state variables include a side slip angle, a filtered yaw rate, a heading error, and a lateral error, and wherein the processor is configured to determine the filtered yaw rate by estimating a yaw rate that considers a longitudinal slip ratio using wheel speed and acceleration of the autonomous vehicle as input, and filtering sensor noise from the yaw rate as estimated.

6. The apparatus of claim 5, wherein the processor is configured to filter sensor noise by determining a weighted average of an estimation of the yaw rate assuming a nonzero tire slip and an estimation of the yaw rate assuming a zero tire slip when the autonomous vehicle decelerates, wherein a weight of the estimation of the yaw rate assuming the nonzero tire slip increases as deceleration increases.

7. The apparatus of claim 1, wherein the slack variables vary based on a distance of the autonomous vehicle to at least one of a boundary or an obstacle.

8. The apparatus of claim 1, wherein the optimization operation jointly minimizes the lateral and heading error as compared to the planned path and steering oscillations.

9. The apparatus of claim 1, wherein the processor is configured to, once the lateral and heading error between a current state of the autonomous vehicle and a desired state of the autonomous vehicle is above a threshold, implement error state saturation logic to restrict a maximum rate of change of a steering angle to limit overcorrection at a future point in a prediction horizon.

10. The apparatus of claim 9, wherein the error state saturation logic is enabled or disabled depending on at least one of a condition of the autonomous vehicle or a condition of the portion of the vehicle transportation network.

11. The apparatus of claim 10, wherein the error state saturation logic is enabled when at least one of a curvature of a lane in the portion of the vehicle transportation network is less than a minimum threshold and a speed of the autonomous vehicle is greater than a maximum threshold.

12. The apparatus of claim 1, wherein the processor is configured to:
determine a state prediction for the autonomous vehicle for use in the optimization operation; and
determine, using the state prediction, a speed reduction for the optimization operation based on a lookahead curvature of the planned path and steering slew rate limitations of the autonomous vehicle.

13. The apparatus of claim 12, wherein the processor is configured to:
access speed-based and curvature-based tuning parameters from a lookup table to determine a speed reduction for multiple time points.

14. The apparatus of claim 1, wherein the processor is configured to:
perform the optimization operation using the lateral offset constraint applied pointwise to avoid any collision with respect to a front bumper of the autonomous vehicle, wherein the lateral offset constraint is based on at least one of a boundary or an obstacle, and using the heading angle constraint to avoid any collision with respect to a rear bumper of the autonomous vehicle, wherein the heading angle constraint is calculated from a rear axle of the autonomous vehicle considering a width of the autonomous vehicle.

15. An autonomous vehicle comprising the apparatus of claim 1.

16. A method for controlling an autonomous vehicle, the method comprising:
receiving, from a trajectory planner, a plan comprising a planned path and a speed plan for the autonomous vehicle to traverse through a portion of a vehicle transportation network;
performing an optimization operation to revise the plan, wherein the optimization operation jointly minimizes a lateral and heading error as compared to the planned path while applying each of a lateral offset constraint and a heading angle constraint as soft constraints, wherein the soft constraints are represented by respective slack variables, and a penalty is applied to at least one of the slack variables that is greater than a penalty applied to the lateral and heading error to prioritize collision avoidance over maintaining the planned path; and
operating at least one control system of the autonomous vehicle according to the plan as revised.

17. The method of claim 16, comprising determining the lateral and heading error using state variables including a side slip angle, a yaw rate, a heading error, and a lateral error generated using a dynamic bicycle predictive model for the autonomous vehicle.

18. The method of claim 16, wherein the slack variables vary based on a distance of the autonomous vehicle to at least one of a boundary or an obstacle.

19. The method of claim 16, wherein the optimization operation jointly minimizes the lateral and heading error as compared to the planned path and steering oscillations.

20. The method of claim 16, comprising:
determining a speed reduction for the optimization operation based on a lookahead curvature of the planned path and steering slew rate limitations of the autonomous vehicle; and
providing the speed reduction as input to the optimization operation.
